(19) United States
(12) Patent Application Publication
(10) Pub. No.: US 2013/0219767 A1
(43) Pub. Date: Aug. 29, 2013

(54) UNIVERSAL FIREARM MOUNT

(71) Applicants: Mitch K. Peterson, North Ogden, UT (US); Kerry L. Peterson, North Ogden, UT (US)

(72) Inventors: Mitch K. Peterson, North Ogden, UT (US); Kerry L. Peterson, North Ogden, UT (US)

(21) Appl. No.: 13/566,152

(22) Filed: Aug. 3, 2012

Related U.S. Application Data
(60) Provisional application No. 61/634,330, filed on Feb. 27, 2012.

(51) Int. Cl. F41C 27/00; B23P 11/00; F41G 1/00

(52) U.S. Cl. 42/113; 42/90; 29/428

(57) ABSTRACT

A system for coupling a red dot sight to a handgun is provided. The system may include a mounting unit made from a single piece of material. The piece may include a male dovetail and a longitudinal rail thereon. The male dovetail may be disposed in a female dovetail of a rear sight portion of the handgun. The longitudinal rail may be configured to receive the red dot sight. The longitudinal rail may define a plurality of lateral slots on the top of the longitudinal rail, and a longitudinal slot extending across the entirety of, and laterally centered on, the top of the longitudinal length of the longitudinal rail. Two visual markers may be located on the back of the longitudinal rail, to the left and right of the longitudinal slot. A tapped aperture may extend through the male dovetail, and a set screw may be disposed therein.

### CROSS-REFERENCE TO RELATED APPLICATIONS

This application claims priority to Provisional U.S. Patent Application No. 61/634,330 filed Feb. 27, 2012, entitled “Red Dot Wedge Mount,” the entire disclosure of which is hereby incorporated by reference, for all purposes, as if fully set forth herein.

### BACKGROUND OF THE INVENTION

This invention relates generally to firearm accessories. More specifically the invention relates to universal mounting of accessories to different individual firearms.

Accessories for firearms are widely available and highly sought after by users, especially when they assist in making a user a more accurate marksman. Examples include red dot sights, holographic sights, Advanced Combat Optical Gunsights (ACOG)/telescopic sights, laser sights, etc. However, problems arise due to the wide variety and design of both the available accessories and firearms to which they may be attached. Potential problems include the inability to use a particular holster with the firearm after the accessory is attached, interference with functioning of existing firearm components, obstruction of existing open sights, or even loss of shooting accuracy because of complexity or quality of attachment mechanisms.

Embodiments of the present invention provide solutions to these and other problems.

### BRIEF DESCRIPTION OF THE INVENTION

In one embodiment, a system for coupling a red dot sight to a handgun is provided. The system may include a mounting unit and a set screw. The mounting unit may include a single piece of material. The single piece of material may include a male dovetail, a tapped aperture, a longitudinal rail, and two visual markers. The male dovetail may be configured to be disposed in a female dovetail of a rear sight portion of the handgun. The tapped aperture may extend through the male dovetail. The longitudinal rail may be above the male dovetail and be configured to receive the red dot sight. The longitudinal rail may define a plurality of lateral slots on the top of the longitudinal rail, and a longitudinal slot extending across the entirety of, and laterally centered on, the top of the longitudinal length of the longitudinal rail. The two visual markers may be located on the back of the longitudinal rail, one to the left of the longitudinal slot, and one to the right of the longitudinal slot. The set screw may be disposed in the tapped aperture, configured to selectively impact the bottom of the female dovetail.

In another embodiment, a system for coupling an accessory to a firearm is provided. The system may include a mounting unit which includes a single piece of material. The single piece of material may include a coupling point and a universal mounting rail. The coupling point may be configured to be coupled with a rear sight portion of the firearm. The universal mounting rail may be configured to receive the accessory.

In another embodiment, a method for coupling an accessory to a firearm is provided. The method may include coupling a mounting unit with a rear sight portion of the firearm. The mounting unit may include a single piece of material having a coupling point configured to be coupled with the firearm, and a universal mounting rail configured to receive the accessory. The method may also include coupling the accessory to the universal mounting rail.

### BRIEF DESCRIPTION OF THE DRAWINGS

The present invention is described in conjunction with the appended figures:

FIG. 1 is a side view of a firearm of the prior art;

FIG. 2 is an axonometric view of the slide of the firearm of FIG. 1, with the rear open sight removed from the female dovetail of the slide;

FIG. 3 is an axonometric view of an alternative prior art slide;

FIG. 4 is an axonometric view of the slide of FIG. 2, but also including a mounting unit embodiment of the present invention located there-above;

FIG. 5 is an axonometric view of the mounting unit from FIG. 4;

FIG. 6 is an axonometric view of an alternative embodiment mounting unit;

FIG. 7 is an axonometric view of another alternative embodiment mounting unit;

FIG. 8 is an axonometric view of yet another alternative embodiment mounting unit;

FIG. 9 is a side view of a red dot sight accessory mounted to a firearm with an embodiment of the present invention; and

FIG. 10 is a block diagram of a method embodiment of the invention for coupling an accessory to a firearm.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, well-known processes, structures, and techniques may be mentioned or discussed without unnecessary detail in order to avoid obscuring the embodiments.

In one embodiment of the invention, a system for coupling one or more accessories to a firearm is provided. The accessories may include sighting systems (red dot sights, reflex sights, holographic sights, ACOG/telescopic sights, laser sights, etc.) as well as other accessories depending on placement of the system on the firearm (tactical lights, grips, bipods, tripods, bayonets, etc.). The firearm may be any possible type of firearm, including for example, a handgun (pistol or revolver), a carbine, a rifle, a shotgun, etc.

The system may include a mounting unit which includes a single piece of material. The material may be a metal (e.g. aluminum, steel, etc.), a polymer (hard or high-impact plastic, etc.), a ceramic, or other material. The material may be formed or machined to the proper shape, and may be surface finished and/or coated (e.g. anodized, cured hardened coatings, etc.).

The single piece of material may include a coupling point and a universal mounting rail. The coupling point may be configured to be coupled with a rear sight portion of the firearm. The universal mounting rail may be configured to receive the accessory.

The coupling point may be of varied construction depending on the embodiment. In some embodiments the coupling point may include a male dovetail configured to mate with a female dovetail on the firearm. The female dovetail of the firearm may originally be intended to couple a rear open sight to the firearm. In some embodiments, the coupling point may have a tapped aperture through which a set screw may be torqued to tighten the mating between the male and female dovetails.

Due to the varied sizes of female dovetails employed by different manufacturers of firearms, different embodiments may have different sized male dovetails to mate congruently therewith. Merely by way of example, the depth of the dovetail may range from about 3 millimeters to about 5 millimeters. The width of the bottom of the dovetail may range from about 6 millimeters to about 12 millimeters. The width of the top of the dovetail may range from about 4 millimeters to about 10 millimeters. The breadth of the dovetail (dimension, left to right of the dovetail slot, on top of the firearm) may be between about 10 millimeters and 30 millimeters, and in some embodiments about 20 millimeters.

In other embodiments, the coupling point may include an aperture through which a machine screw or other fastener may pass and couple with the firearm, thereby securing the mounting unit to the firearm. The tapped hole on the firearm may be located at or near a rear sighting mechanism. In some embodiments, an underside of the mounting unit may be shaped to congruently mate with a top of the firearm, depending specifically on the firearm to which it is attached.

The universal mounting rail may be of any particular design, including for example a Picatinny or Weaver universal rail. The universal mounting rail may have a plurality of regularly spaced lateral slots along its longitudinal length. These slots may assist in mounting an accessory to the universal rail. The length of the universal mounting rail may be configured to conform to the available space on top of a particular model of firearm, or shorter depending on a user's preference or a minimum space necessary for particular accessories.

In some embodiments, the universal mounting rail may include a longitudinal slot extending across the entirety of, and laterally centered on, the top of its length. This longitudinal slot may substitute for the original open sights of the firearm, thereby allowing the front open sight to be used after attachment of the mounting unit to the firearm. In some embodiments, the longitudinal sight may be wider at the front than at the rear of the rail to provide a clearer sight picture to the user.

The back of the rail may include a visual marker or markers to complete a typical open rear sight (and coordinate with the front open sight). In one embodiment this might be a visual marker, perhaps a circle or dot, on each of the left and right side of the longitudinal slot. The type of markings could be consistent with markings used by the original firearm rear sight. In some embodiments, the markings could include tritium night sights.

In another embodiment of the invention, a particular system for coupling a red dot sight to a handgun is provided. The system may include a mounting unit and a set screw. The mounting unit may include a single piece of material. The single piece of material may include a male dovetail, a tapped aperture, a longitudinal rail, and two visual markers. The male dovetail may be configured to be disposed in a female dovetail of a rear sight portion of the handgun. The tapped aperture may extend through the male dovetail. The longitudinal rail may be above the male dovetail and be configured to receive the red dot sight.

The longitudinal rail may define a plurality of lateral slots on the top of the longitudinal rail, and a longitudinal slot extending across the entirety of, and laterally centered on, the top of the longitudinal length of the longitudinal rail. The two visual markers may be located on the back of the longitudinal rail, one to the left of the longitudinal slot, and one to the right of the longitudinal slot. The set screw may be disposed in the tapped aperture, configured to selectively impact the bottom of the female dovetail.

In some embodiments, one or more additional set screws in tapped apertures may be provided at other points along the longitudinal rail. Such set screws may be disposed either between the lateral slots or at any point in the longitudinal slot. These additional set screws may assist in providing additional stabilization and securement of the mounting unit with the firearm. In some embodiments, a hole may be machined into the firearm such that the additional set screw may thread into the firearm, as well as the mounting unit, providing further securement.

In another embodiment of the invention, a method for coupling an accessory to a firearm is provided. The method may initially include removing a rear sight from the rear sight portion of the firearm. The method may further include coupling a mounting unit with a rear sight portion of the firearm.

Coupling the mounting unit with the rear sight portion of the firearm may be accomplished in a number of ways as described herein. In one embodiment, it may include disposing a male dovetail of the mounting unit into a female dovetail of the rear sight portion of the firearm and tightening a set screw therein. In another embodiment, a machine screw or other fastener may secure the mounting unit via an aperture in the mounting unit and a tapped hole on the firearm.

The mounting unit may include a single piece of material having a coupling point configured to be coupled with the firearm, and a universal mounting rail configured to receive the accessory. The method may also include coupling the accessory to the universal mounting rail. In many embodiments the accessory may be coupled with the universal mounting rail after the mounting unit is coupled with the firearm. In certain embodiments, the accessory may instead be coupled with the universal mounting rail before the mounting unit is coupled with the firearm.

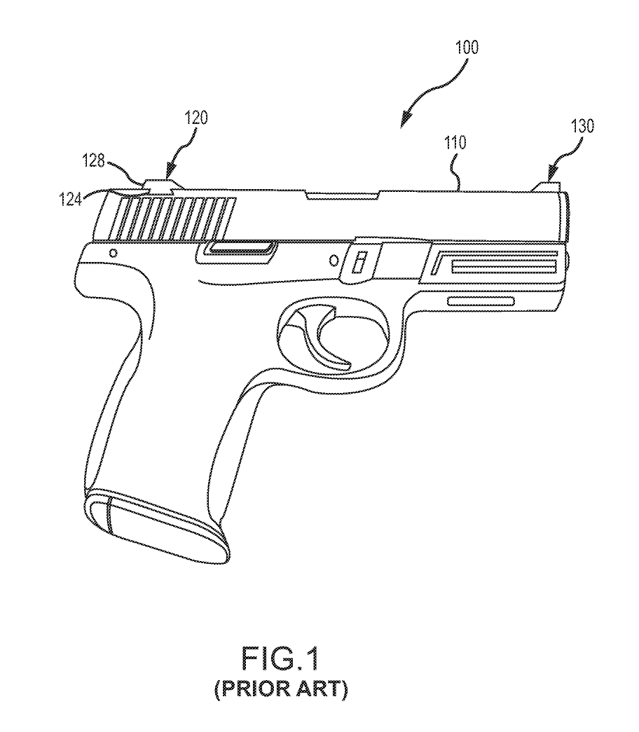

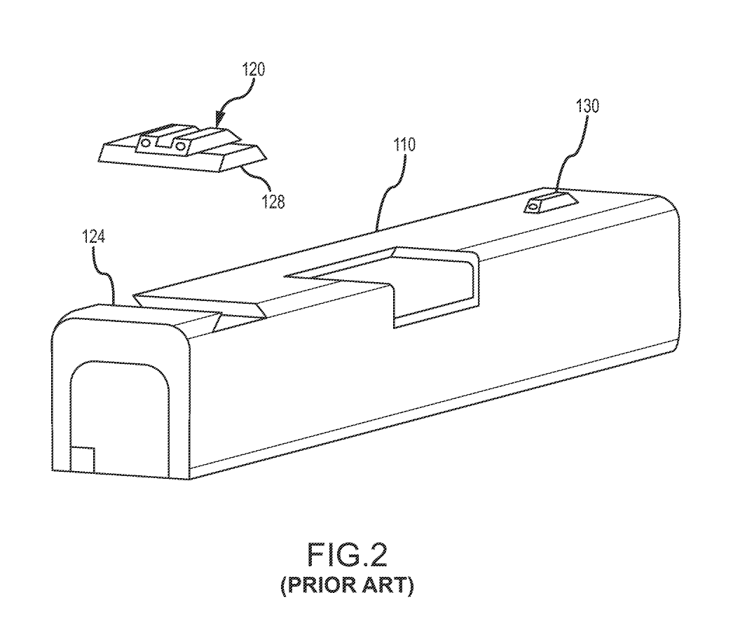

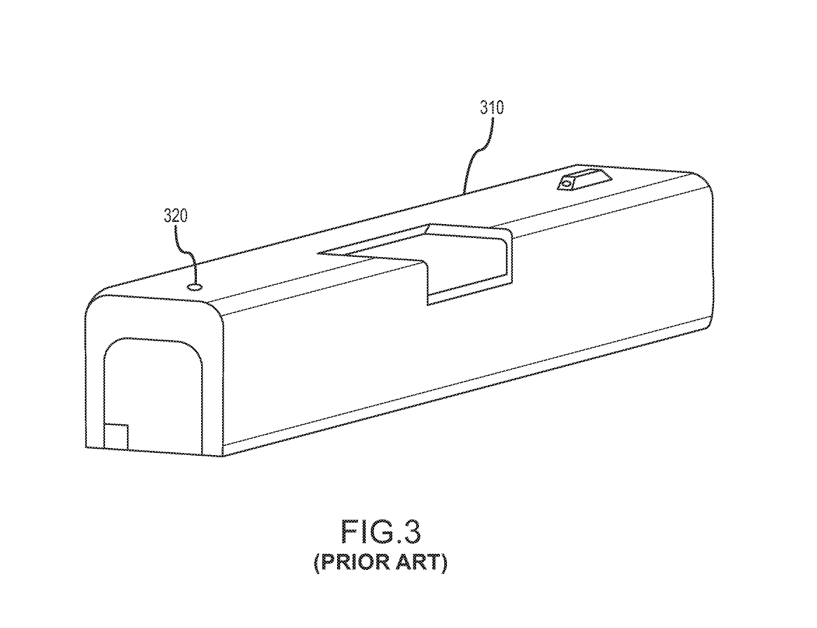

Turning now to FIG. 1, a side view of a firearm 100 of the prior art is shown. Firearm 100 includes a slide 110 having a dovetail rear sight 120. Rear sight 120 includes a female dovetail 124 and a male dovetail 128. A front sight 130 is also shown. FIG. 2 shows an axonometric view of slide 110 of firearm 100 from FIG. 1, with rear sight 120 removed from female dovetail 124 of slide 110. FIG. 3 shows an axonometric view of an alternative prior art slide 310. Slide 310, instead of a female dovetail, includes a threaded hole 320 at the rear sight portion thereof. In these prior art embodiments, a rear open sight is coupled directly to slide 310 via a machine screw or other fastening mechanism.

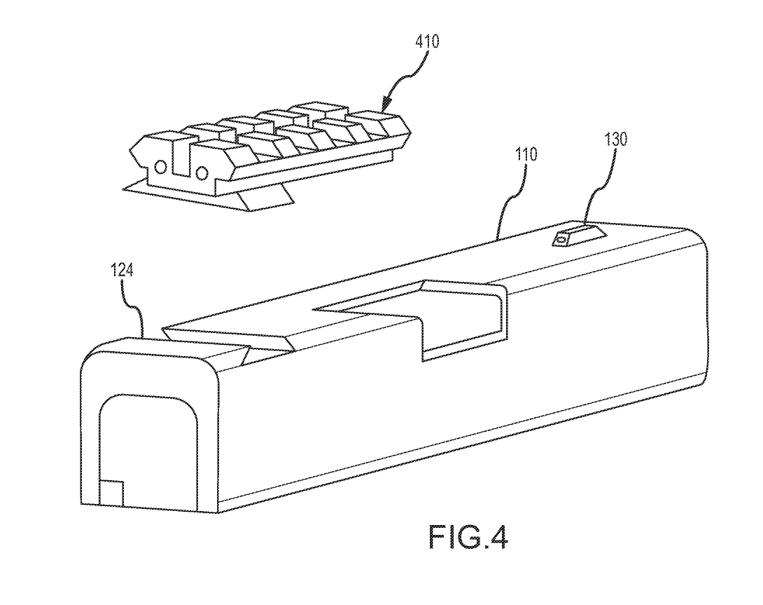

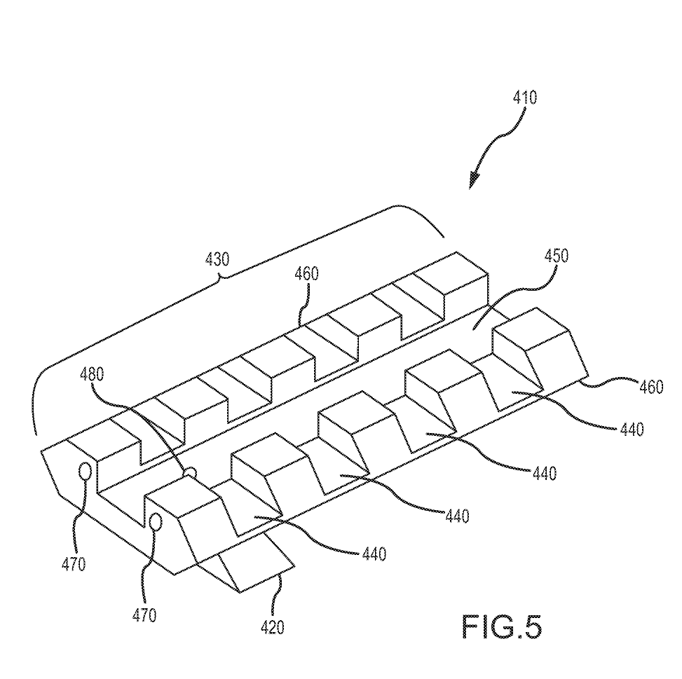

FIG. 4 shows an axonometric view of slide 110 of FIG. 2, but also including a mounting unit 410 of one embodiment of the present invention located there-above. FIG. 5 shows a close-up axonometric view of mounting unit 410. Mounting unit 410 includes a male dovetail 420 and a universal mounting rail 430. Universal mounting rail 430 may include a plurality of lateral slots 440, and one longitudinal slot 450.

Lateral slots 440, along with longitudinal edges 460 may be used to couple accessories to universal mounting rail 430. Jaws of an accessory extend to the left and right of edges 460, and are then tightened via a screw or other mechanism which traverses through lateral slots 440.

Longitudinal slot 450, in conjunction with markings 470 may be used as an open rear sight in conjunction with front sight 130 on slide 110, once male dovetail 420 is inserted into female dovetail 124 of firearm 100. Upon insertion, set screw 480 may be tightened to secure mounting unit 410 to firearm 100, and prevent unwanted movement between the two parts.

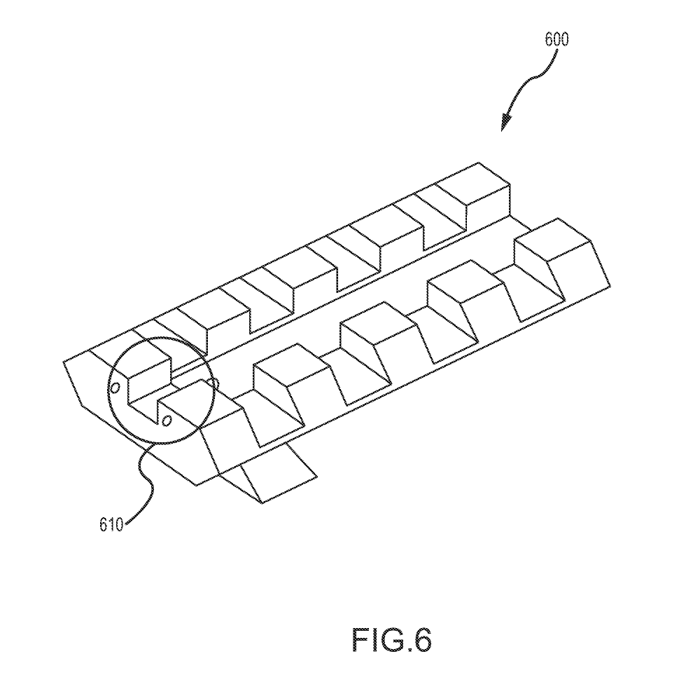

FIG. 6 shows an axonometric view of an alternative embodiment mounting unit 600. In this embodiment, the rear portion 610 of the longitudinal slot is narrower and not as deep as the forward portion of the longitudinal slot. This may improve visual sight picture for a user employing mounting unit 610 as a rear sight for the firearm.

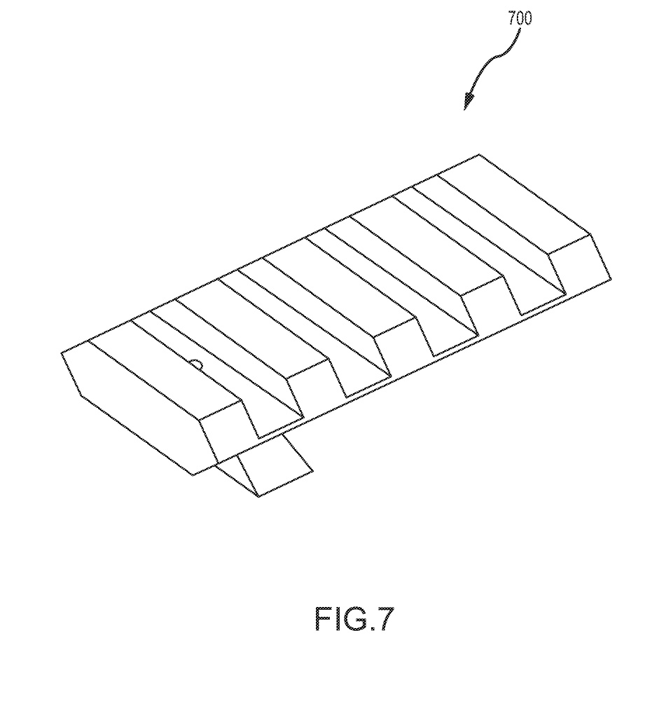

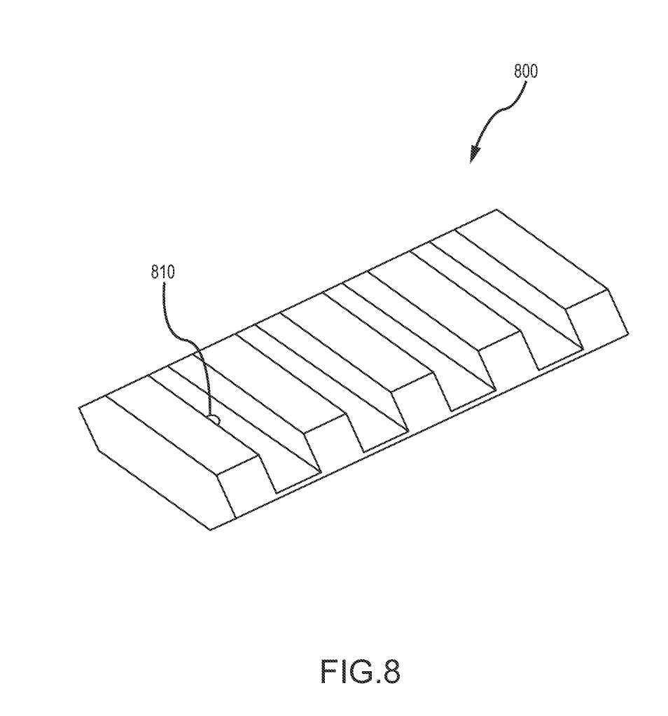

FIG. 7 shows an axonometric view of another alternative embodiment mounting unit 700. In this embodiment, mounting unit 700 may not have a longitudinal sight. FIG. 8 shows an axonometric view of yet another alternative embodiment mounting unit 800. In this embodiment, mounting unit 800 does not include a male dovetail, and instead the coupling point is an aperture 810, either threaded or unthreaded, which allows a fastener to pass through and couple with the firearm, thereby securing mounting unit 800 thereto.

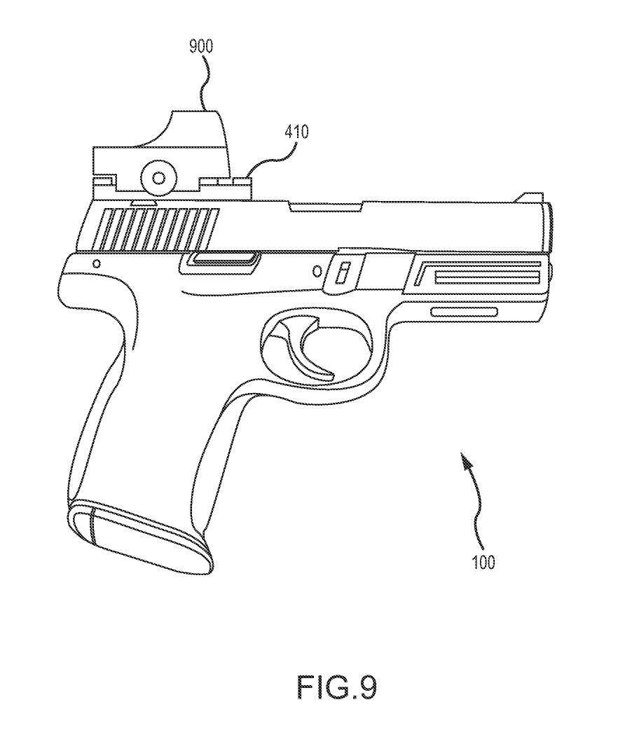

FIG. 9 shows a side view of a red dot sight accessory 900 mounted to firearm 100 with mounting unit 410. In this manner, a simple and secure mounting system is provided for allowing red dot sight, and other accessory use, with firearm 100.

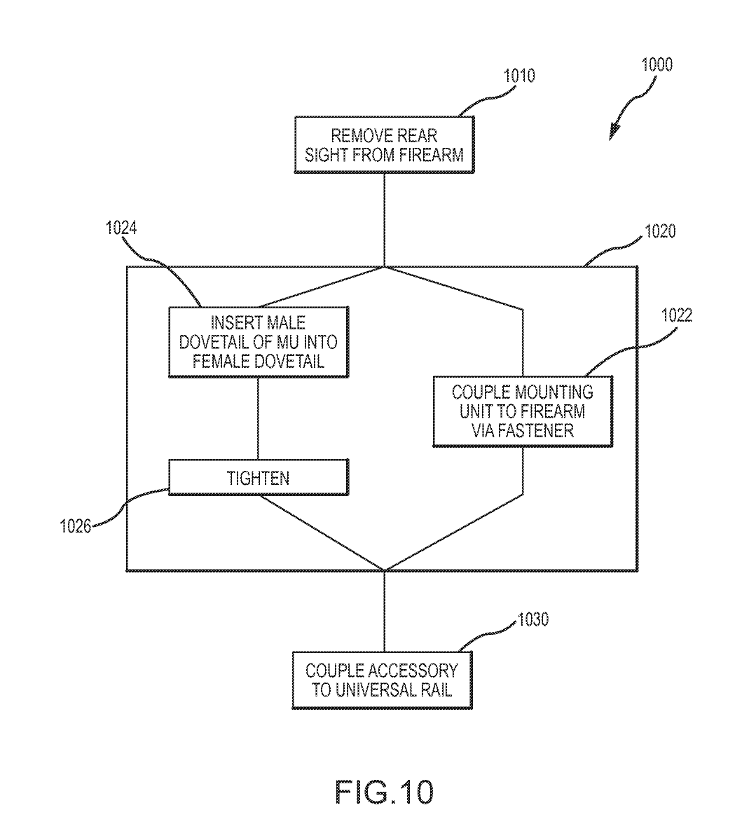

FIG. 10 shows a block diagram of a method 1000 of the invention for coupling an accessory to a firearm. At block 1010, a pre-existing rear sight is removed from the firearm. At block 1020, the mounting unit is secured to the firearm in place of the pre-existing rear sight. This may occur in at least two possible fashions.

At block 1022, the mounting unit may be coupled to the firearm via a fastener such as a machine screw, using a threaded hole on the rear sight potion of the firearm. The fastener may pass through a portion of the mounting unit, and then couple with the firearm to secure the mounting unit thereto.

Alternatively, at block 1024, if the firearm has a female dovetail at its rear sight portion, the mounting unit may be provided with a male dovetail portion and disposed in the female dovetail. At block 1026, a set screw or other mechanism may be used to tighten the connection between the two dovetails.

At block 1030, an accessory, such as a red dot sight, may be coupled to the mounting unit, thereby coupling the accessory with the firearm. While in most embodiments the accessory will be coupled with the mounting unit after attachment of the mounting unit with the firearm, in other embodiments the reverse may occur.

The invention has now been described in detail for the purposes of clarity and understanding. However, it will be appreciated that certain changes and modifications may be practiced within the scope of the appended claims.

What is claimed is:

1. A system for coupling a red dot sight to a handgun, wherein the system comprises:
a mounting unit, wherein the mounting unit comprises a single piece of material having:
a male dovetail configured to be disposed in a female dovetail of a rear sight portion of the handgun;
a tapped aperture extending through the male dovetail;
a longitudinal rail above the male dovetail configured to receive the red dot sight, wherein the longitudinal rail defines:
a plurality of lateral slots on the top of the longitudinal rail; and
a longitudinal slot extending across the entirety of, and laterally centered on, the top of the longitudinal length of the longitudinal rail;
two visual markers on the back of the longitudinal rail, one to the left of the longitudinal slot, and one to the right of the longitudinal slot; and
a set screw disposed in the tapped aperture, configured to selectively impact the bottom of the female dovetail.

2. The system for coupling a red dot sight to a handgun of claim 1, wherein:
the width of the longitudinal slot is greater at the front of the longitudinal rail than at the back of the longitudinal rail.

3. A system for coupling an accessory to a firearm, wherein the system comprises:
a mounting unit, wherein the mounting unit comprises a single piece of material having:
a coupling point configured to be coupled with a rear sight portion of the firearm; and
a universal mounting rail configured to receive the accessory.

4. The system for coupling an accessory to a firearm of claim 3, wherein:
the single piece of material further defines a tapped aperture extending through the coupling point.

5. The system for coupling an accessory to a firearm of claim 3, wherein the system further comprises:
a set screw disposed in the tapped aperture.

6. The system for coupling an accessory to a firearm of claim 3, wherein the coupling point comprises:
a male dovetail configured to be disposed in a female dovetail of the rear sight portion of the firearm.

7. The system for coupling an accessory to a firearm of claim 3, wherein the coupling point comprises:
an underside of the mounting unit shaped to congruently mate with a top of the firearm.

8. The system for coupling an accessory to a firearm of claim 3, wherein the coupling point comprises:
an aperture defined by the mounting unit and configured to accept a fastener configured to be coupled with the firearm.

9. The system for coupling an accessory to a firearm of claim 3, wherein the universal mounting rail comprises:
a longitudinal rail defining:
a plurality of lateral slots on the top of the longitudinal rail; and
a longitudinal slot extending across the entirety of, and laterally centered on, the top of the longitudinal length of the longitudinal rail.

10. The system for coupling an accessory to a firearm of claim 9, wherein:
the width of the longitudinal slot is greater at the front of the longitudinal rail than at the back of the longitudinal rail.

11. The system for coupling an accessory to a firearm of claim 9, wherein the longitudinal rail comprises:
two visual markers on the back of the longitudinal rail, one to the left of the longitudinal slot, and one to the right of the longitudinal slot.

12. The system for coupling an accessory to a firearm of claim 11, wherein the visual markers comprise tritium night sights.

13. The system for coupling an accessory to a firearm of claim 3, wherein the universal mounting rail comprises:
a Picatinny rail.

14. The system for coupling an accessory to a firearm of claim 3, wherein the universal mounting rail comprises:
a Weaver rail.

15. The system for coupling an accessory to a firearm of claim 3, wherein the accessory comprises:
a red dot sight.

16. A method for coupling an accessory to a firearm, wherein the method comprises:
coupling a mounting unit with a rear sight portion of the firearm, wherein the mounting unit comprises a single piece of material having:
a coupling point configured to be coupled with the firearm; and
a universal mounting rail configured to receive the accessory; and
coupling the accessory to the universal mounting rail.

17. The method for coupling an accessory to a firearm of claim 16, wherein the method further comprises:
removing a rear sight from the rear sight portion of the firearm.

18. The method for coupling an accessory to a firearm of claim 16, wherein the coupling point comprises a male dovetail, and coupling the mounting unit the rear sight portion comprises:
inserting the male dovetail into a female dovetail of the rear sight portion of the firearm.

19. The method for coupling an accessory to a firearm of claim 16, wherein coupling the mounting unit the rear sight portion comprises:
coupling a fastener with the firearm through an aperture defined by the mounting unit.

20. The method for coupling an accessory to a firearm of claim 16, wherein coupling the mounting unit with the rear sight portion of the firearm occurs prior to coupling the accessory to the universal mounting rail.
